(19) United States
(12) Patent Application Publication
(10) Pub. No.: US 2017/0036926 A1
(43) Pub. Date: Feb. 9, 2017

(54) Water Sanitizing System

(71) Applicant: Ryland Wilson, Falkville, AL (US)

(72) Inventor: Ryland Wilson, Falkville, AL (US)

(21) Appl. No.: 14/820,123

(22) Filed: Aug. 6, 2015

(51) Int. Cl. C02F 1/467; C02F 1/78

(52) U.S. Cl. CPC C02F 1/4674; C02F 1/4672; C02F 1/78; C02F 2201/461; C02F 2201/46155; C02F 2209/02; C02F 2303/04; C02F 2305/023

(57) ABSTRACT

The present invention relates to a portable water purification and sanitizing apparatus and method. Due to the limited size of the apparatus and its ability to utilize DC power, the apparatus can be transported and operated in remote areas across the globe. The apparatus and method generates electrolytic products of chlorine, hydroxide and ozone that are utilized to purify and sanitize water for human consumption.

### STATEMENT REGARDING PRIOR DISCLOSURES BY THE INVENTOR OR JOINT INVENTOR

The inventor did not disclosed the invention herein prior to the 12 month period preceding the filing of this nonprovisional application.

### BACKGROUND OF THE INVENTION

(1) Field of the Invention

The present invention relates to a method and an apparatus for sanitizing water for human consumption. This method and apparatus has a number of applications such as disinfection of water for personal and commercial purposes, such as purification of water for pools and spas and other recreational activities, purification of drinking water, and purification of water for use in commercial establishments.

(2) Description of Related Art

In many areas of the undeveloped world, there is a need for cheap, sustainable water treatment. The water treatment system or method must be portable so that it can be distributed into remote regions around the globe. The World Health Organization estimates that globally, at least 1.8 billion people use a drinking-water source contaminated with feces. Contaminated water can transmit diseases such as diarrhea, cholera, dysentery, typhoid, and polio. Following natural disasters, many people in less developed areas of the world, are unable to find safe water for drinking, cooking, and bathing. A portable, cheap, and easy to use method and apparatus is needed to rid water of harmful bacteria and viruses. This method and apparatus should be easy to use so that people with little or no education can perform the necessary steps. Typically, water is disinfected using one or more of the following methods: boiling, ultraviolet radiation, ozonation, reverse osmosis, and chlorination. Boiling requires the input of firewood and creates large quantities of smoke, that can damage the environment and be harmful if inhaled. Both ultraviolet radiation and ozonation require expensive equipment and may require special training to operate and maintain the equipment. Reverse osmosis requires pre-filtration and is expensive to perform and maintain. Chlorination is relatively cheap, easy to perform, and protects the water against contamination following disinfection.

Numerous devices and methods have been disclosed that sanitize and purify water for human use. Namespetra et al. (U.S. Pat. No. 7,959,872 B2) discloses a pitcher device including extruded carbon sheet or granulated activated carbon to filter unpurified, gravity-fed water. This device requires the carbon to be positioned above the water level maintained within the pitcher and would not function to disinfect the quantities of water necessary for a family's daily needs. Namespetra et al. (U.S. Pat. No. 7,767,168 B2) discloses a sanitation system that sanitizes water by the incorporation of ozone into the water, which is circulated by a pump. Barnes (U.S. Pat. No. 8,075,784 B1) and Barnes (U.S. Pat. No. 7,883,622 B1) disclose the use of the combination of chlorine and ozone to sanitize water. The Barnes devices require high oxidation potentials from ozone, which is generated with an ultraviolet ozone generator. An ozone generator adds costs and complexity to the treatment of water. Additionally, the Barnes devices require one or more venturi to increase the flow of water and solutes through the water treatment system. Vandenbelt et al. (US 2008/0314808 A1) discloses a hand-held pitcher device that filters small batches of water using ozone generated by a UV line radiator inside the pitcher. Although hand-held pitcher devices are highly portable and easy to use, they are not able to effectively purify sufficient quantities to meet a typical family's daily water needs. Because ozone has a very short half life, water disinfected using ozone may be quickly re-contaminated. Thus, the devices utilizing ozonation are not effective in providing adequate water supplies to impoverished regions.

Garcia (U.S. Pat. No. 6,814,877 B2) combines ozonation and chlorination to purify water for swimming pools, ponds, aquatic mammal tanks, and spas or fountains. Garcia employs chlorine dioxide as a disinfectant. This method is not suitable for drinking water because just one half a drop of chlorine dioxide can cause severe nausea, diarrhea and vomiting. McCague (U.S. Pat. No. 8,273,254 B2) discloses a spa sanitation system that includes an ozone generator, a chlorine generating cell to generate chlorine and other sanitizing agents for sanitizing the water, a calcium remover bag, and adding salt to the water. This system is built into a whirlpool and requires a contact chamber of 8 to 10 feet in length. Thus, this method is not portable, and is unsuitable for use in remote areas of the world.

Swartz et al. (US 2011/025760 A1) discloses a electrolyzing system for electrolyzing a brine solution of water and an alkali salt to produce acidic electrolyzed water and alkaline electrolyzed water. The invention of Swartz et al. includes a series of ion permeable membranes that concentrate ions in water to produce acidic sanitizer and, separately, base cleaners. Water is drawn into the top of the device, ions from a brine solution are concentrated in the water, acidic and basic solvents drain separately from the bottom of the device. The invention of Swartz et al. could not be used to produce drinking water or to sanitize water for a pool or spa because it produces acidic and basic solvents that are not suitable for human consumption. The device of Miller et al. (U.S. Pat. No. 4,121,991) discloses an electrolytic cell for the treatment for the purification and sterilization of water for human use. Water enters the Miller et al. device from the bottom and exits from the top of the device. Water entering the Miller et al. device must have been previously chlorinated to a level of 3 ppm chloride ions. This device would not purify or sanitize water that had not been previously chlorinated or sanitized. Thus, this device requires multiple steps which add to its complexity and, therefore, limit its usage by unsophisticated users and limits its use in remote areas across the undeveloped world.

McGuire (U.S. Pat. No. 6,368,472 B1) discloses an apparatus for generating chlorine and ozone for water disinfection wherein the apparatus is relatively portable and the individual parts are somewhat inexpensive. McGuire discloses a anolyte reaction chamber attached to a anode plate and a catholyte reaction chamber attached to a cathode plate. The anolyte and catholyte plates have at least one sealing gasket interposed between them so as to form a reaction chamber wherein electrolysis chemicals are produced. These electrolyte chemicals are then pumped through water for an hour or more to disinfect and purify the water. This device has many disadvantages including, but not limited to: there are a number of individual parts that must be obtained and assembled correctly to create the device, all of these parts may not be obtainable in many undeveloped areas, assembly of the device can be confusing and difficult for someone lacking basic plumbing or mechanical skills, the device only accepts DC power, the device must be rotated about its horizontal axis so that the cathode chamber is rotated downward in order to prevent the accumulation of hydrogen gas within the device, byproducts of the device include bleach and hydrogen peroxide that must be disposed of properly, the pump must be placed within a drum, cistern, or tank of sufficient size, the reaction chamber must be secured to a tree, post, or some other solid object, and the device can only be operated outside or in a well ventilated area. These disadvantages limit the use of the McGuire device. A new apparatus and method is needed that eliminates these disadvantages.

Typically, water treatment methods and systems are costly to operate, large in size, require high inputs of energy, and require the addition of chemicals, which are often caustic, to function properly A need exists for a water disinfection method and apparatus that is cheap, easy to transport, easy to install, easy to operate, that doesn't require special, caustic chemicals to operate, doesn't produce caustic chemicals requiring disposal. The Water Sanitizing System meets these needs and will enable the poorest people throughout the world to clean and disinfect their water supply at an extremely low financial cost without the addition of either toxic chemicals or costly energy resources. And, this method and apparatus may be utilized by spa, fountain, and pool owners to disinfect water.

### BRIEF DESCRIPTION OF THE SEVERAL VIEWS OF THE DRAWINGS

FIG. 1 illustrates an exterior, side view of the Water Sanitizing System.

FIG. 2 illustrates an exterior, side view of the lid.

FIG. 3 illustrates an exterior, side view of the canister.

FIG. 4 illustrates an exploded, side view of the lid, heat exchanger and electrical wires.

FIG. 5 illustrates a front view of the electrode.

FIG. 6 depicts an exploded, side view of the electrode assembly.

FIG. 7 depicts an exterior, side view of the Water Sanitizing System with circular electrodes.

FIG. 8 depicts an exploded, side view of the lid, electrode wires, optional thermostat, and optional aerator of the circular electrode embodiment.

FIG. 9 illustrates an exploded, side view of the lid, canister, electrode assembly, electrical wires, and heat exchanger for the circular-shaped electrode embodiment.

FIG. 10 depicts a side view of the sigmoid-shaped heat exchanger.

FIG. 11 depicts an exploded, side view of the circular electrode embodiment.

### DETAILED DESCRIPTION OF THE INVENTION

The invention is described in detail in the following paragraphs with reference to the attached drawings. Throughout this detailed description of the invention, the disclosed embodiments and features are to be considered as examples, rather than being limitations to the invention. Modifications to particular examples within the spirit and scope of the present invention, set forth in the appended claims, will be readily apparent to one of ordinary skill in the art. Further, reference to various embodiments of the disclosed invention does not mean that all claimed embodiments or methods must include every described feature. The various disclosed embodiments and features of the invention may be used separately or together, and in any combination. Terminology used herein is given its ordinary meaning consistent with the exemplary definitions set forth below.

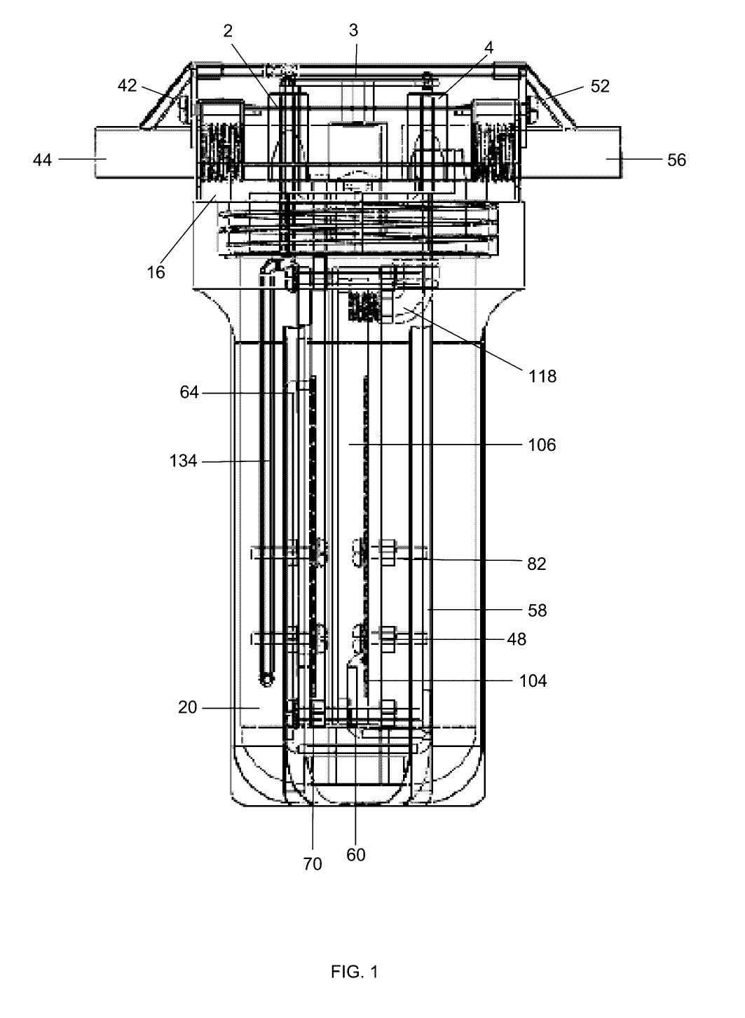

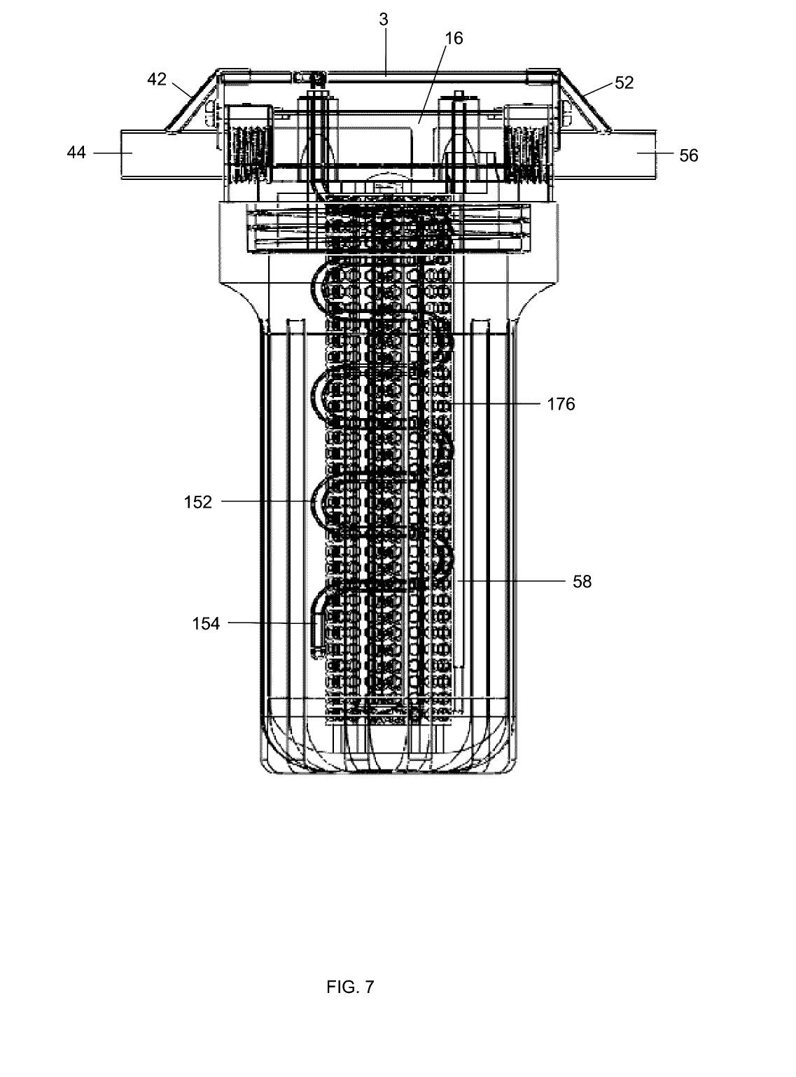

FIGS. 1 through 6 depict an embodiment of the Water Sanitizing System with a linear electrode assembly and FIGS. 7 through 11 depict the device with a circular electrode assembly.

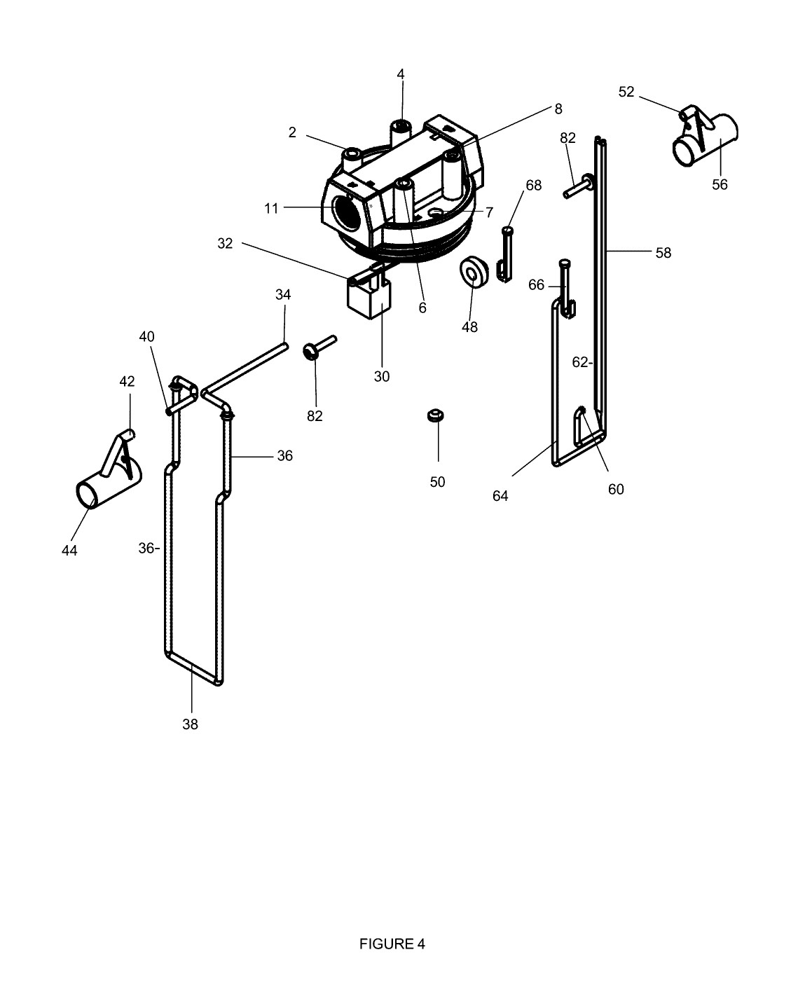

FIG. 1 illustrates an exterior, side view of the Water Sanitizing System. The Water Sanitizing System may be coupled to a cistern holding water. Water from the cistern may be pumped via a common water pump into the device for sanitizing. Lid 16 is shown attached to canister 20. Port 4 located on lid 16 may be utilized to anchor electrical wires 58 and 62 (shown in FIG. 4) to the lid. Port 2 of lid 16 is shown securing the heat exchanger tube 36 (shown in FIG. 4) into the correct position within the device. Water flows into canister 20 for sterilizing via intake fitting 44. A portion of water entering the intake fitting 44 is diverted through the diverter 42 into water circulator 3, and to the heat exchanger tube 36. Water circulator 3 connects diverter 42 to mixer fitting 52 and allows water to bypass heat changer 36 and exit the device via outlet fitting 56. The heat exchanger allows heat generated in canister 20 to be absorbed by the cooler water passing through heat exchanger tube 36 (shown in FIG. 4) and to exit canister 20 via mixer fitting 52, which mixes the heated water in the heat changer tube 36 with water exiting canister 20 through outlet fitting 56. Long and short electrical wires, 58 and 62 (shown in FIG. 4) respectively, run the length of electrode frame 106, make a 90° turn before running the width of electrode frame 106, make a second 90° turn before running along the width of electrode frame 106, and terminating at the face of negative electrode 104 and positive electrode 70, respectively. Positive electrode 70 is shown with screws 82 and nuts 48 which are used secure the parts of the device together and to space the distance that electrodes 70 and 104 are from the electrical wires and from electrode frame 106. Optional thermostat sensor 134 is shown in FIG. 1.

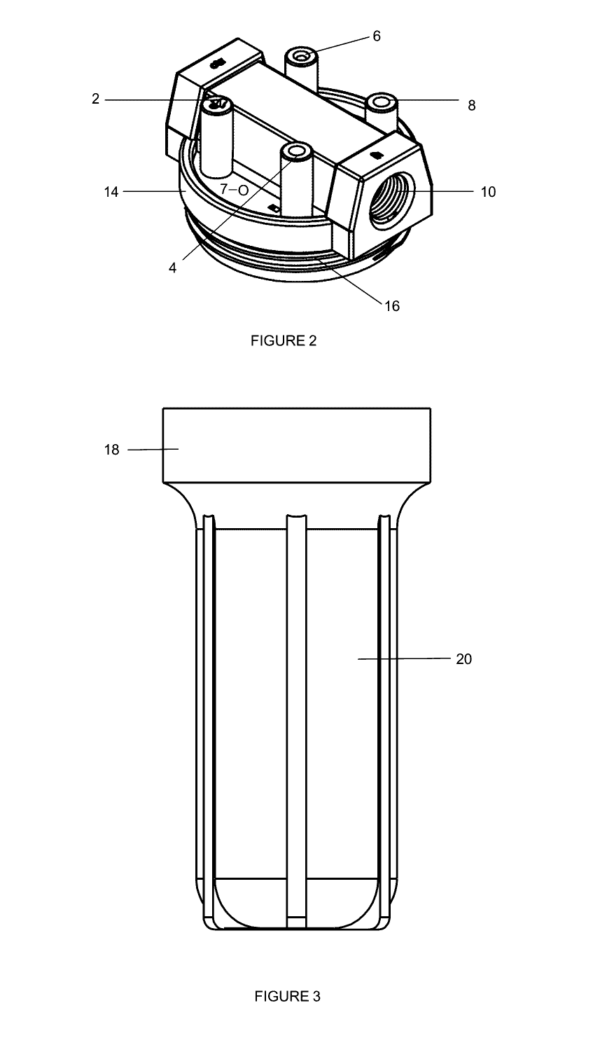

FIG. 2 illustrates an exterior, side view of lid 16. Lid 16 may include inlet 11 (shown in FIG. 4) that allows contaminated water to enter the device and outlet 10 that allows purified and sanitized water to exit the device. Lid 16 may include brim 14 which is gripped by a user when screwing lid 16 onto and off of canister grip 18 (shown in FIG. 3) via tapered threads 16. Ports 2 and 8 may be utilized to circulate water through the heat exchanger (34, 36, 38, and 40, shown in FIG. 4). The heat exchanger (34, 36, 38, and 40, shown in FIG. 4) should be composed of or coated with a non-conductive material so that it does not interact with the electrodes in the device. Port 4 may be used to anchor and attach the electrical wires (58, 60, 62, and 64, shown in FIG. 4) that power the device. Port 6 may be used to mount or anchor the device in a fixed position. For example, the device may be anchored to a cistern via port 6. The device may include hole 7 to allow excess gas formed during the sanitization process to vent from canister 20 (shown in FIG. 1).

Canister 20 is depicted in FIG. 3. Canister 20 may be composed of any clear material that allows a user to view the internal components of the device, such as glass, plastic, poly propylene or other suitable material. Canister 20 should be composed of a material that is resistant to corrosion and microbial growth. Additionally, canister 20 must be composed of a material that is resistant to heat, chlorine, hydroxide, ozone and contaminated water. It is imperative that canister 20 be sufficiently clear so that a user can observe the sanitizing process to ensure that the device is working properly. Water and table salt are mixed to form a brine. The user may mix as little as 15 grams of salt per liter of brine to as much as 227 grams of salt. The brine is contained within canister 20. The salt in the water is converted via electrolysis to chlorine gas, hydroxide gas, and ozone. These gases mix with the contaminated water fed to the device sanitizing said water. Canister 20 may hold approximately 1 liter of brine solution.

FIG. 4 illustrates an exploded, side view of lid 16, heat exchanger (34, 36, 38, and 40), and electrical wires (58, 60, 62, and 64). Both the heat exchanger (34, 36, 38, and 40) and the electrical wires (58, 60, 62, and 64) anchor into lid 16. The heat exchanger (34, 36, 38, and 40) may anchor into ports 2 and 6. The heat exchanger (34, 36, 38, and 40) is comprised of a hollow, medium pressure copper-nickel tube. The heat exchanger (34, 36, 38, and 40) must be composed of a corrosion-free material. The heat exchanger (34, 36, 38, and 40) reduces the water temperature within canister 20 by circulating water from the cistern through the exchanger (34, 36, 38, and 40). Heat created during the sanitizing process are transferred to the cooler temperature of the water entering inlet 11, which prevents a significant increase in the temperature of the brine. Water enters inlet 11 through fitting 44. Fitting 44 is a hollow tube that may be composed of rubber, plastic or any hard material resistant to heat, ionic gases, and water. Fitting 44 includes diverter 42. Diverter 42 is a hollow protrusion that diverts water entering inlet 11 via fitting 44 into the heat exchanger (34, 36, 38, and 40). The heat exchanger (34, 36, 38, and 40) is a hollow tube formed to fit along the electrode assembly 17 (shown in FIG. 6). The heat exchanger (34, 36, 38, and 40) is comprised of the following segments: a short horizontal projection 40, two vertical projections 35 and 36, a horizontal base projection 38, and a horizontal lid projection 34. The short horizontal projection 40 connects the diverter 42 to a vertical projection 35. Vertical projections 35 and 36 run the vertical length of the electrode assembly 17. Vertical projection 35 connects to the horizontal base projection 38 that runs the width of the electrode assembly 17. Horizontal base projection 38 connects to the second vertical projection 36. The second vertical projection 36 connects to the horizontal lid projection 34, which feds the water to port 8 on the lid 16.

Water flowing through port 8, flows into mixer fitting 52. Mixer fitting 52 is a hollow projection stemming from outlet fitting 56. Outlet fitting 56 is a hollow fitting that connects to outlet port 10 of lid 16. Water heated due to the transfer of heat from the electrode assembly 17 to the water traversing the heat exchanger (34, 36, 38, and 40) exits the device via outlet fitting 56 and flows back to the water cistern.

FIG. 4 depicts the attachment of chlorometer 30 to the device. Chlorometer 30 may be attached to the horizontal lid projection 34 via chlorometer fitting 32. Chlorometer fitting 32 is a hollow tube that is sized to connect to the chlorometer 30 to port 8. Chlorometer 30 is a commercially available product that quantifies the concentration of chlorine in water. Chlorometer 30 may be installed along the heat exchanger (34, 36, 38, and 40) because it measures the chlorine concentration of water being pumped from the cistern. Chlorometer 30 must be connected to the DC power source that powers the device. Chlorometer 30 allows the user to determine if the device has been sufficiently chloronated, and hence, adequately sanitized and killed suspected microbial contamination. Chlorometer 30 can be configured to shut off power to the device when the desired chlorine concentration is obtained in the water. If salt water is used with the device, then excess salt may not need to be added. If using fresh water in the Water Sanitizing System, salt will need to be added to water to produce a brine solution. For example, a user may add 227 grams or a cup of salt to two liters of fresh water. If a large cistern of water is to be sanitized, then the device may be scaled up to hold much more than two liters of brine solution. A final concentration of 2.0 mg/L of chlorine per fresh water must be obtained within the cistern to destroy all organism but does not provide sufficient levels of chlorine to deal with future contamination that may occur during storage and transport. A concentration of 2.5 mg/L of chlorine will destroy all organisms while leaving a concentration of 0.5 mg/L to prevent future contamination. Previous use of the device has enabled the purification of 18.9 kL of contaminated water with a level of 5 mg/L chlorine atoms with just 227 grams of salt having been mixed with 1.89 L of water. If the water is purified to a level of 5 mg/L, then the water must sit for approximately 24 hours or until the chlorine levels drop below 3 mg/L before human consumption.

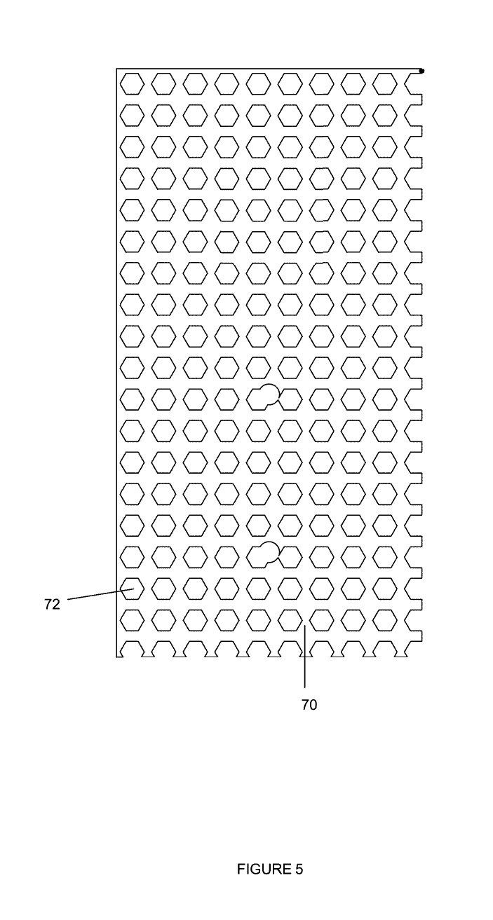

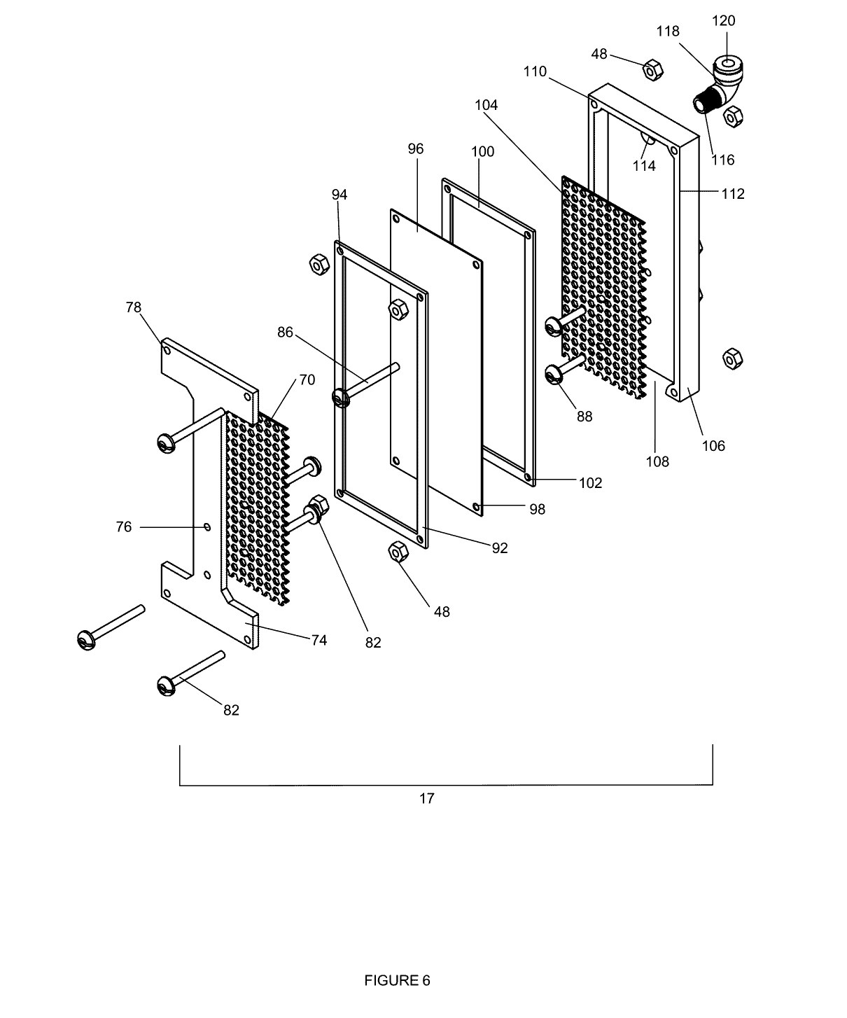

The straight ends of both the long electrical wire 62 and the short electrical wire 58 fit within port 4 of lid 16 anchoring the wires into the device. A DC power source is attached to long electrical wire 62 and short electrical wire 58 to power the device. The device may be powered by any power supply as known in the art, including a DC power supply, solar panels, battery or batter charger. While the device is preferably powered by about 6 to 12 volts DC, lower voltage will power the device at a reduced rate. The device may be powered by full wave and half wave pulsed DC. However, half wave pulsed DC will reduce the rate of chlorine gas production and the rate of water sanitization. Although DC power powers the electrical wires, AC power supplied by a standard power line can be converted to DC power to power the device. Both the long and short electrical wires, 62/64 and 58/60 respectively, provide electrical power to power the electrolytic conversion of salt into chlorine gas and hydroxide. The long and short electrical wires, 62/64 and 58/60 respectively, are configured so that long wire 62/64 sends power to the negative or anode electrode 70 (shown in FIG. 5 and FIG. 6) while short wire 58/60 transmits power to the positive or cathode electrode 104 (shown in FIG. 6). The electrical charge powers the conversion of salt in the brine into Na+ and Cl− ions, hyroxide ions, and ozone. These electrolytes sanitize and purify the contaminated water moving through canister 20.

Screw 82 is used to attach the heat exchanger (34, 36, 38, and 40) to lid 16. Screw 82 is nestled in the elbow connecting the second vertical projection 36 to the horizontal lid projection 34. Screw 82 is anchored into tab bracket 66 via nut 48. Tab bracket 66 includes head 68, which is pushed into a slot on the inside face of lid 16. Long electrical wire 64 fits snugly into tab bracket 66. Tab bracket head 68 anchors the long electrical wire 64 into an opening on the inside face of lid 16 securing long electrical wire 64 into position along the electrode assembly 17 (shown in FIG. 6).

Hole 7, if included in the device, permits the flow of exhaust gases out of the device for venting into the air. Plug 50 fits into hole 7 plugging the exhaust of gas when an optional means to exhaust excess gas is employed.

FIG. 5 depicts the positive or cathode electrode 70. Positive electrode 70 contains a number of openings 72 that allow for the free movement of ions and brine solution through the electrode assembly 17. Openings 72 increase the surface area for the electrolytic reaction, thus allowing a greater quantity of electrolytes to be produced. The Water Sanitizing System requires both a positive or cathode electrode 70 and a negative or anode electrode 104 (shown in FIG. 6). Both electrodes 70 and 114 must be equal in size and must be configured so that the mass of electrode 70 faces the mass of electrode 114. This provides for more efficient conductivity, which enhances electrolytic production and water sanitization. Electrodes 70 and 114 must have current applied to opposing ends of the opposing electrode. For example, if the positive wire 58 connected to positive electrode 70 is placed on the top center of positive electrode 70, then negative electrode 114 should have the negative wire 62 placed at the bottom center of the negative electrode. The positive electrode 70 generates ozone radicals and hydrogen gas, while the negative electrode 114 generates chlorine gas and hydroxide. The electrolytes migrate though the brine and the contaminated water sanitizing the water. A permeable ion membrane (shown in FIG. 6) is placed between the electrodes 70 and 114. Electrodes 70 and 114 must not touch each other or the ion membrane. Electrodes 70 and 114 must be spaced an equal distance from each other and an equal distance from the ionic membrane. A non-conductive, non-corrosive washer can be used as a spacer to space the membrane equal distance between electrodes 70 and 114. Electrodes 70 and 114 are composed of stainless steel, titanium, expanded titanium, zirconium, expanded zirconium, hafnium, expanded hafnium, niobium, expanded niobium, nickel, expanded nickel, chromium, expanded chromium, a transition metal, a metal alloy, a combination thereof, or any suitable material.

FIG. 6 illustrates the electrode assembly 17. The electrode assembly 17 may include “I”-shaped bar 74, positive electrode 70, ionic membrane frame (parts 92 and 100), ionic membrane 96, negative electrode 104, electrode frame 106, exhaust elbow 118, and an assortment of non-corrosive screws 82 with non-corrosive nuts 48. “I” bar 74 is a non-conductive, non-metal bar composed of plastic, or any similar material. “I” bar 74 secures positive electrode 70 into position. The Water Sanitizing System is more efficient at sanitizing contaminated water than the prior art because positive electrode 70 is not housed within a sealed chamber. “I” bar 74 contains holes 76 and 78 through which screw 82 is inserted to anchor the positive electrode 70 a set distance from the ionic membrane frame 92. Ionic membrane frame 92 and 100 frame ionic membrane 96 on both sides of said membrane 96. Screws 82 fit through holes 94 and 102 to secure ionic membrane 96 to the electrode frame 106. The ionic membrane 96 allows cations, such as sodium ions, to travel from the negative or anode electrode 104 towards the positive or cathode electrode 70 while resisting the flow of positively charged species across the membrane from the positive electrode 70 to the negative electrode 104. The ionic membrane should be the same approximate length and width of electrodes 70 and 104. Ionic membranes capture viruses and large parties while allowing certain ions to freely pass through pores within said membrane. A number of suitable ionic membranes are commercially available. The negative electrode 104 is positioned within electrode frame 106. Electrode frame 106 is a box created by two vertical arms that are at least as long as negative electrode 104 that are connected via an upper horizontal arm that is at least as wide as the width of electrode 104. The electrode frame 106 is sealed on three sides using a sealant known in the art such as room temperature vulcanizing silicone. The bottom of electrode frame 108 is open. During the sanitization process, brine and water enter into the electrode frame 106 via opening 108. The frame opening 108 dramatically increases the efficiency of chlorine gas production during sanitization and, thus, increases the rate of sanitization. Other electrolyte generators and water sanitizing systems have one or more closed anionic/cationic chambers that a reduce rate of both water sanitization and electrolyte production. Electrode frame 106 includes a number of holes 110 sized to fit screws 82. Screws 82 may be fitted through holes 78 located on “I” bar 74, through holes 94 located on the ionic membrane frame 92, into holes 110 positioned on electrode frame 106. Electrode frame 106 includes hole 114, which is centered along the upper frame arm. Hole 114 is sized to permit the exhaust elbow 118 to fit securely into said hole 114 via tapered end 116. Exhaust elbow 118 is hollow and includes exhaust outlet 120. Excess gas produced in the electrode assembly is vented through exhaust elbow 118 and out exhaust outlet 120. Water Sanitizing System devices lacking an exhaust elbow 118 may vent excess gases through hole 7 positioned on lid 16 (shown on FIG. 2). Additionally, if there is sufficient draw within canister 20, external air may enter electrode frame 106 via exhaust elbow 118.

Brine solution within canister 20 must be maintained at a level that is approximately 25 mm over the top of positive electrode 70 and negative electrode 104 for optimum performance of the device.

An optional thermostat 130 may be installed on the device to shut the device down if the temperature within canister 20 rises above a predetermined value, such as 87° C. Additionally, optional aerator 140 may be added to the device to pump air into canister 20 to facilitate the production of electrolytes and the movement of gases into and out of the device during the sanitization process.

If a user desires to sanitize a large quantity of water, then two or more Water Sanitizing System devices may be installed in a series to increase the yield of sanitized water and the rate of sanitization.

FIG. 7 depicts an external, side view of the Water Sanitizing System with circular electrodes. Contaminated water flows into intake fitting 44 on lid 16 and enters canister 2. Water circulator 3 connects diverter 42 to mixer fitting 52 to allow for the movement of water to heat exchange tubing 152. Heat exchange tubing 152 runs the width and length of positive electrode 176, and may form a number of “S” or sigmoid-shaped elbows. Short electrical wire 58 is visible through canister 20.

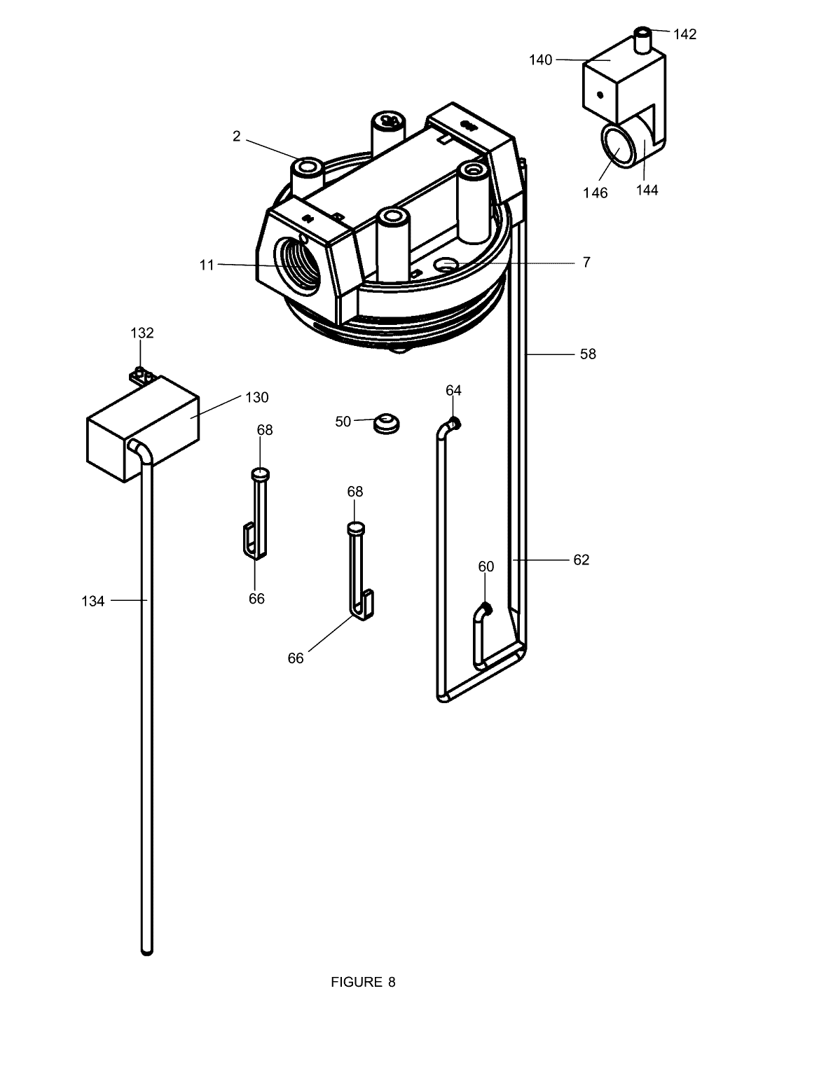

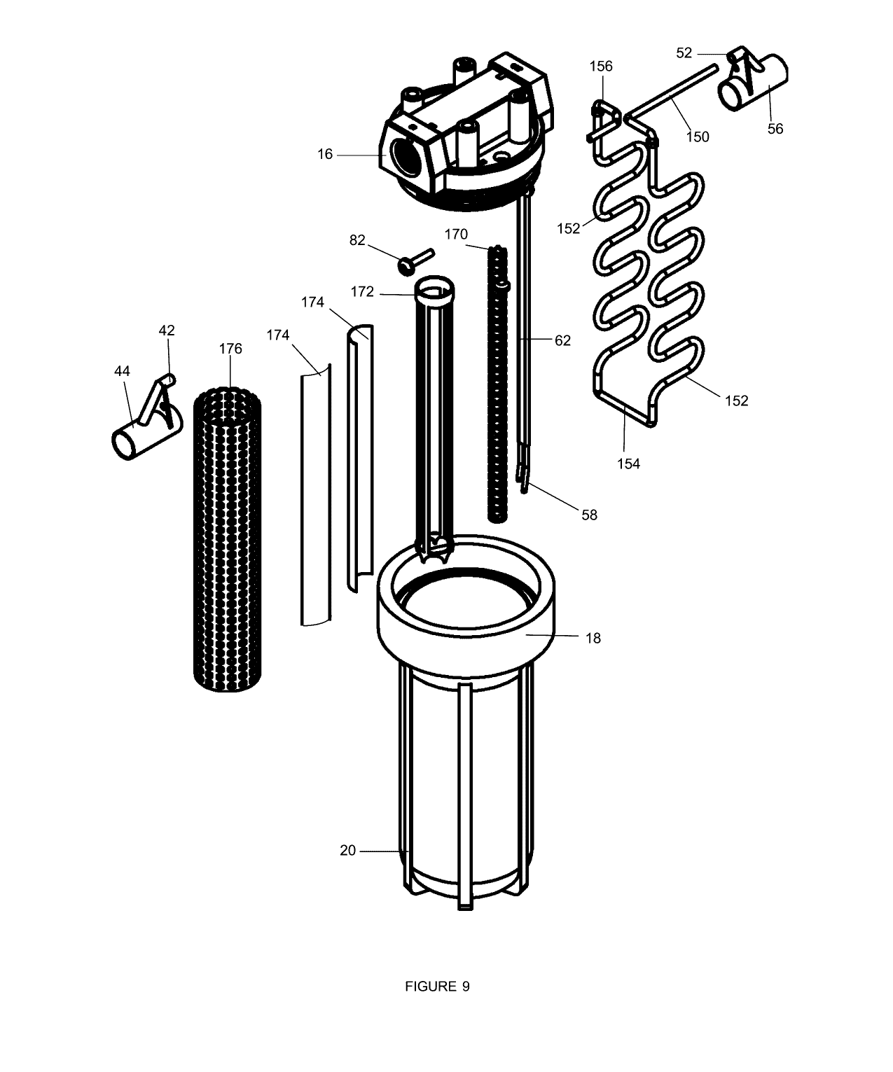

An exploded, side view of lid 16, electrode wires 58/60 and 62/64, heat exchanger (150, 152, 154, and 156), electrode assembly 19 (170, 172, 174, and 176), optional thermostat 130, and optional aerator 140 of the circular embodiment is shown in FIG. 8. Optional thermostat 130 includes sensor 134 that detects the temperature of the water/brine solution within canister 20. Thermostat 130 is powered via the DC power supplied to connector 132. Optional aerator 140 may be installed in the device by inserting aerator tab 142 into hole 7. Water and brine solution are aerated as the fluid is pumped through aerator pipe 146. Aerator 140 also operates on DC power that is supplied to the device. If aerator 140 is not used, plug 50 may be used to plug hole 7. Long electrical wire 62 runs the length and width of positive electrode 176 (shown in FIG. 9) creating a long hook 64 that terminates at the top of said electrode 176 hooking onto the inside wall of the electrode 176. Short electrical wire 58 runs the length and width of the negative electrode 170 creating a short hook 60 that terminates at the top of said electrode 170 hooking onto the inside wall of the electrode 170. Tab brackets 66 are used to secure the long electrical wire 64 and the thermostat 130 into the inside face of lid 16.

FIG. 9 depicts an exploded, side view of the lid, canister, heat exchanger, and electrode assembly. The long and short electrical wires (62 and 58, respectively) are shown installed within a port of lid 16. The heat exchanger (150, 152, 154, and 156) connects to water diverter 42 of intake fitting 44 via tubing section 156. The heat exchanger (150, 152, 154, and 156) has two vertical sections 152 that run horizontally the width of the electrode assembly, make an 180° turn, and run the horizontal width of the electrode assembly (150, 152, 154, and 156) creating a “S”-shaped pattern. Two vertical sections 152 are connected to each other via horizontal tube 154 near the bottom of canister 20. Heat exchanger tubing 150 connects the heat exchanger (150, 152, 154, and 156) to water circulator 52 of outlet fitting 56. Electrode frame 172 seals negative electrode 170 on all sides except for the bottom, which is open to allow for the flow of water and brine into the electrode assembly 19. Two ionic membrane filters 174 are placed against electrode frame 172 sealing the vertical surfaces of electrode frame 172. Filters 174 create a tight seal preventing the free flow of water and brine through the vertical surfaces of the frame 172. Positive electrode 176 is positioned outside of ionic membrane filters 174 so that filters 174 are equally spaced between electrodes 170 and 176.

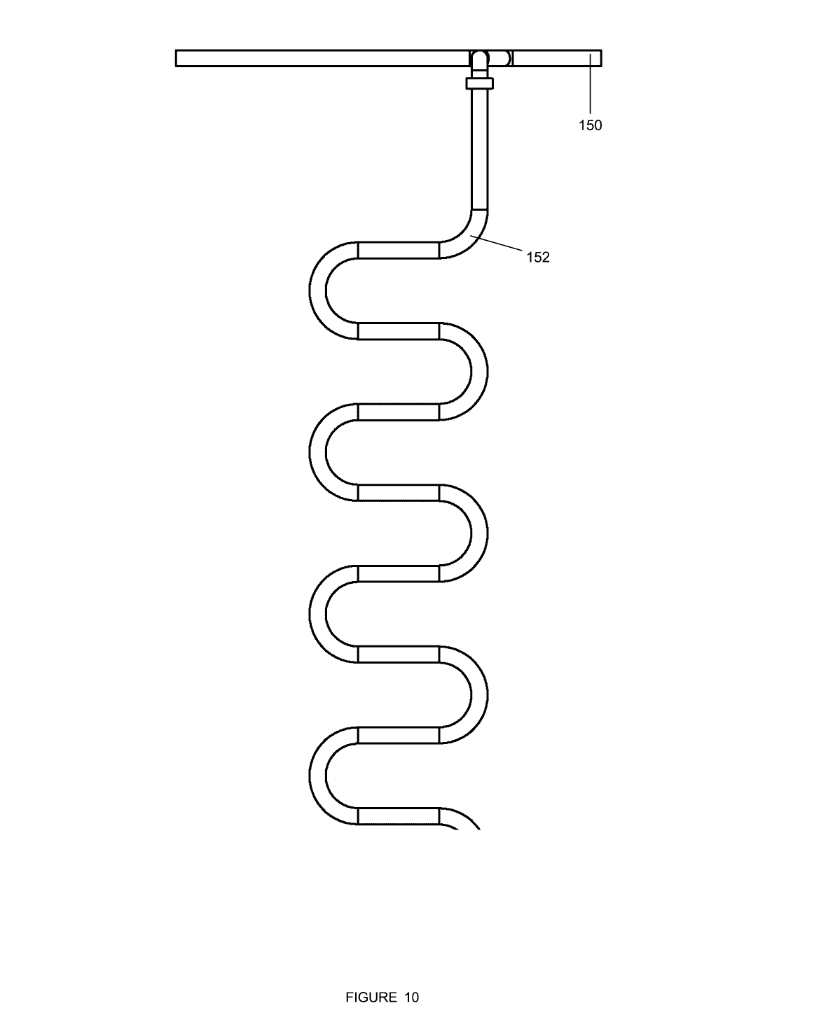

A side view of vertical section 152 of the heat exchanger (150, 152, 154, and 156) and the heat exchange tubing 150 is shown in FIG. 10.

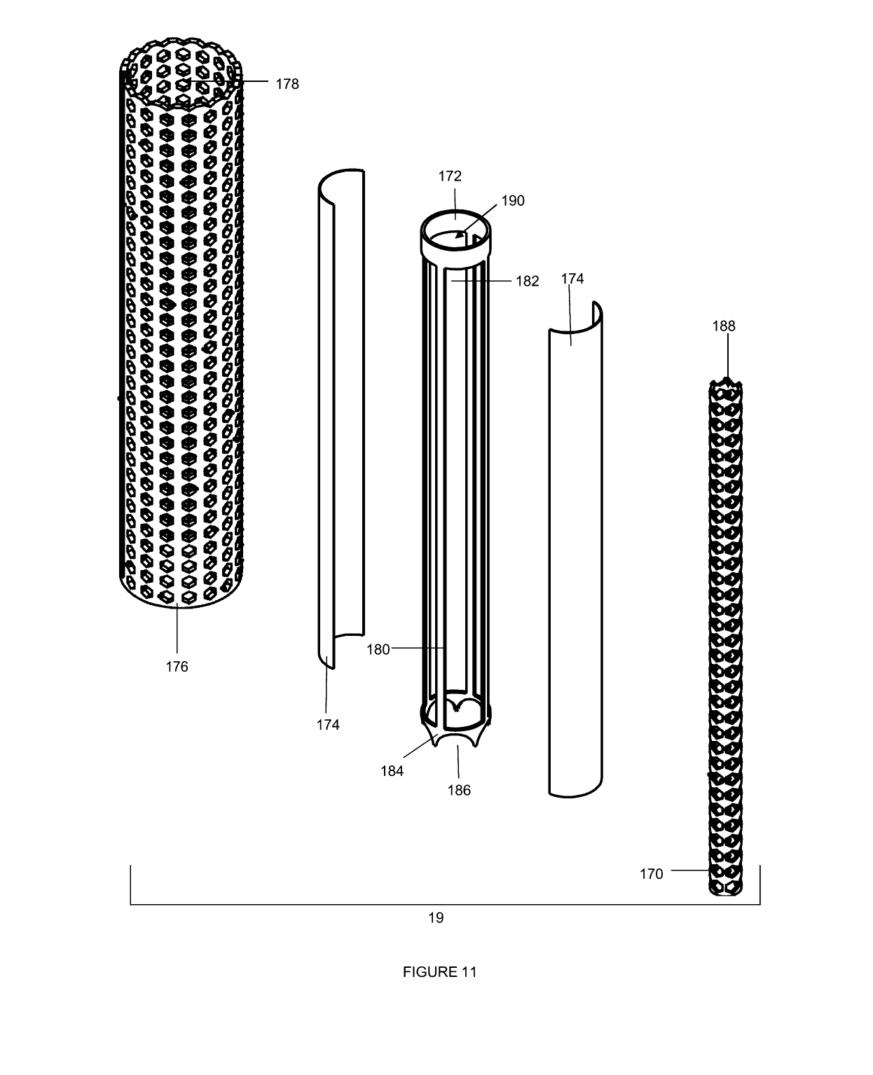

FIG. 11 illustrates an exploded, side view of the electrode assembly 19. Negative electrode 170 is hollow with cavity 188 for the flow of water and brine to increase the surface area of electrode 170, which increases the electrolytic capacity of the device. Negative electrode 170 nests within electrode frame 172. Electrode frame 172 includes hollow cavity 190 to position negative electrode 172 within the electrode assembly 19. Two ionic membrane filters 174 with a semi-circular shape are positioned against electrode frame arms 180 to create a seal. The bottom of electrode frame 172 includes triangular ends 184 that create open channels 186 that permit the free flow of water and brine into hollow cavity 188. Positive electrode 176 includes cavity 178 that allows it to be fitted over electrode frame 172. This device increases the rate of sanitization and the efficiency of chlorine gas production during sanitization than what is available in the prior art.

Having thus described our invention, and the manner of its use, it should be apparent to one of average skill in the arts that incidental changes may be made thereto that fairly fall within the scope of the following appended claims, wherein I claim:

The inventor hereby claims:

1) An apparatus for generating at least one chemical by electrolysis comprising:
a positive or cathode plate not contained within a reaction chamber;
a negative or anode plate opposing said positive or cathode plate;
an anolyte reaction chamber enclosing said negative or anode plate, said anolyte reaction chamber is sealed on all sides except the bottom of said anolyte reaction chamber is open or has one or more openings to allow the flow of fluid into said anolyte reaction chamber, said anolyte reaction chamber being in fluid communication with said negative or anode plate; and
said positive or cathode plate and said negative or anode plate are in fluid communication with each other.

2) The apparatus of claim 1 wherein said positive or cathode plate is composed of stainless steel, titanium, expanded titanium, zirconium, expanded zirconium, hafnium, expanded hafnium, niobium, expanded niobium, nickel, expanded nickel, chromium, expanded chromium, a transition metal, a metal alloy, or a combination thereof.

3) The apparatus of claim 1 wherein said negative or anode plate is composed of stainless steel, titanium, expanded titanium, zirconium, expanded zirconium, hafnium, expanded hafnium, niobium, expanded niobium, nickel, expanded nickel, chromium, expanded chromium, a transition metal, a metal alloy, or a combination thereof.

4) The apparatus of claim 1 wherein an ionic membrane is positioned an equal distance between the positive or cathode plate and the negative or anode plate.

5) The apparatus of claim 1 wherein a thermostat regulates the temperature of fluid within said apparatus.

6) The apparatus of claim 1 wherein an aerator adds air to fluid within said apparatus.

7) The apparatus of claim 1 wherein a heat exchanger removes heat from fluid in communication with the positive or cathode plate or the negative or anode plate.

8) The apparatus of claim 1 wherein said apparatus includes a clear or transparent container to house said apparatus.

9) The apparatus of claim 7 wherein the container includes a detachable lid, said lid containing one or more openings to allow the venting of gases produced during electrolysis, said lid containing one or more openings to allow for the movement of fluid into and out of the apparatus, said lid containing one or more openings to allow for the attachment of electrical wires to power the electrolytic process, and said lid containing one or more openings to allow for the removal of heat from said apparatus.

10) A method of generating at least one chemical by electrolysis comprising:
a positive or cathode plate not contained within a reaction chamber;
a negative or anode plate opposing said positive or cathode plate;
an anolyte reaction chamber enclosing said negative or anode plate, said anolyte reaction chamber is sealed on all sides except the bottom of said anolyte reaction chamber is open or has one or more openings to allow the flow of fluid into said anolyte reaction chamber, said anolyte reaction chamber being in fluid communication with said negative or anode plate; and
said positive or cathode plate and said negative or anode plate are in fluid communication with each other.

11) The method of claim 10 wherein said positive or cathode plate is composed of stainless steel, titanium, expanded titanium, zirconium, expanded zirconium, hafnium, expanded hafnium, niobium, expanded niobium, nickel, expanded nickel, chromium, expanded chromium, a transition metal, a metal alloy, or a combination thereof.

12) The method of claim 10 wherein said negative or anode plate is composed of stainless steel, titanium, expanded titanium, zirconium, expanded zirconium, hafnium, expanded hafnium, niobium, expanded niobium, nickel, expanded nickel, chromium, expanded chromium, a transition metal, a metal alloy, or a combination thereof.

13) The method of claim 10 wherein an ionic membrane is positioned an equal distance between the positive or cathode plate and the negative or anode plate.

14) The method of claim 10 wherein a thermostat regulates the temperature of fluid within said apparatus.

15) The method of claim 10 wherein an aerator adds air to fluid within said apparatus.

16) The method of claim 10 wherein a heat exchanger removes heat from fluid in communication with the positive or cathode plate or the negative or anode plate.

17) The method of claim 10 wherein said apparatus includes a clear or transparent container to house said apparatus.

18) The method of claim 17 wherein the container includes a detachable lid, said lid containing one or more openings to allow the venting of gases produced during electrolysis, said lid containing one or more openings to allow for the movement of fluid into and out of the apparatus, said lid containing one or more openings to allow for the attachment of electrical wires to power the electrolytic process, and said lid containing one or more openings to allow for the removal of heat from said apparatus.
